(19) United States
(12) Patent Application Publication
(10) Pub. No.: US 2026/0103063 A1
(43) Pub. Date: Apr. 16, 2026

(54) METHOD FOR CONVERSION OF LEGACY TRUCKS TO ELECTRICAL POWER

(71) Applicant: AstroLectric LLC, Manhattan Beach, CA (US)

(72) Inventors: John Daniel Olivas, Manhattan Beach, CA (US); Anselmo Najera, Sunland Park, NM (US)

(73) Assignee: AstroLectric LLC, Manhattan Beach, CA (US)

(21) Appl. No.: 18/914,029

(22) Filed: Oct. 11, 2024

(51) Int. Cl. B60K 1/04; B60K 1/00; B60K 6/22

(52) U.S. Cl. CPC B60K 1/04; B60L 50/60; B60K 2001/003

(57) ABSTRACT

A method for converting a vehicle such as a legacy pick-up truck with an internal combustion engine to an all-electric vehicle. The method includes removing substantially all of the subsystems of the vehicle and then reconfiguring the various new and previous subsystems to cooperate with an electrical power supply. Such subsystems include the braking, suspension and drive train, steering, exhaust, cooling and air conditioning. Each subsystem is reengineered (or eliminated in the case of the exhaust system) to optimize the new power system while maintaining the original look and feel of the vintage pick-up truck.

### BACKGROUND

Converting a vehicle from an internal combustion engine (ICE) to an electric vehicle (EV) presents a multitude of challenges. One of the primary difficulties lies in the complexity of the conversion process itself. The ICE and EV powertrains are fundamentally different in terms of their design, components, and operation. Removing the engine, fuel tank, and associated systems requires careful reengineering of the vehicle's architecture. This often entails significant modifications to the chassis, which must accommodate the weight and dimensions of the electric motor and battery packs. Ensuring proper integration while maintaining vehicle safety and performance standards is a daunting task that requires specialized knowledge and skills.

Another challenge is the selection and installation of appropriate battery systems. The battery is a critical component of any EV, influencing everything from range to charging times. Choosing the right type, size, and configuration of batteries can be a complex decision, as it must align with the vehicle's intended use and performance goals. Additionally, considerations around battery management systems (BMS) and thermal management become vital to ensure efficiency and longevity. The weight of the batteries can also affect the vehicle's balance and handling characteristics, requiring further adjustments to the suspension and braking systems.

Also, regulatory compliance presents another layer of complexity. Different regions have varying regulations regarding vehicle modifications, emissions standards, and safety requirements. Understanding and adhering to these regulations is crucial, as failing to do so could render the converted vehicle illegal for road use. This can involve extensive paperwork, inspections, and even modifications to meet local laws. Navigating through these bureaucratic hurdles can be time-consuming and frustrating, often overshadowing the technical aspects of the conversion itself.

### SUMMARY OF THE INVENTION

With these challenges in mind, the present invention relates to a method for converting a vehicle such as a legacy pick-up truck with an internal combustion engine to an all-electric vehicle. The method includes removing substantially all of the subsystems of the vehicle and then reconfiguring the various new and previous subsystems to cooperate with an electrical power supply. Such subsystems include the braking, suspension and drive train, steering, exhaust, cooling and air conditioning. Each subsystem is reengineered (or eliminated in the case of the exhaust system) to optimize the new power system while maintaining the original look and feel of the vintage pick-up truck. These and other features of the invention will best be understood with reference to the accompanying figures and the detailed description of the invention set forth below.

### BRIEF DESCRIPTION OF THE DRAWINGS

FIG. 1 is a side view of a prior art vehicle with an internal combustion engine;

FIG. 2 is a side view, partially in shadow, of the vehicle of FIG. 1 with various original subsystems intact;

FIG. 3 is a side view, partially in shadow, of the vehicle of FIG. 1 with multiple subsystems removed;

FIG. 4 is a side view of the vehicle of FIG. 1 with replaced suspension elements and front/rear disc brakes;

FIG. 5A is a front view of the front suspension after replacement;

FIG. 5B is a top view of the front suspension after replacement; and

FIG. 6 is a side view, partially in shadow, of a reconfigured vehicle according to the present invention.

### DETAILED DESCRIPTION OF THE PREFERRED EMBODIMENTS

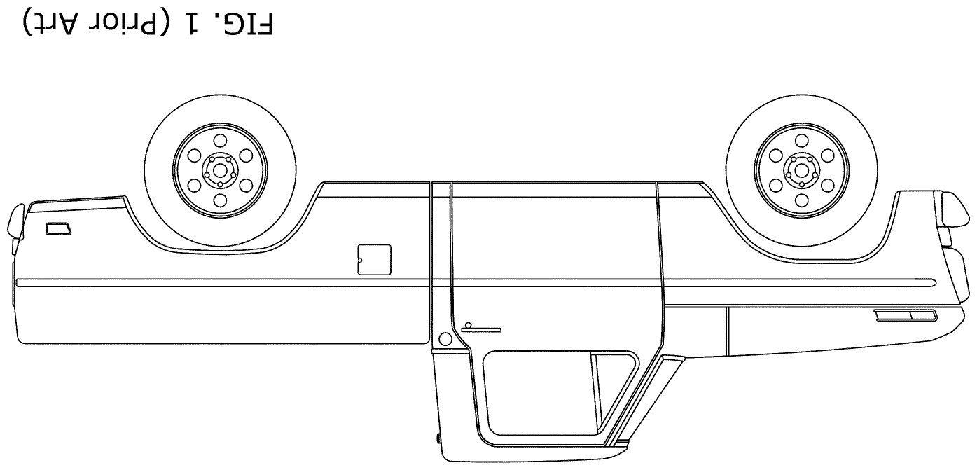

The present invention envisions the conversion of an internal combustion engine (ICE) powered vehicle (see, e.g., FIG. 1) to a fully electric vehicle (EV). The methodology detailed herein can be used, for example, on the Ford F-100 (1967 through 1972) with either a short or long bed configuration, although the invention is not limited specifically to this/these model(s). The approach facilitates the use of originally manufactured equipment with only the necessary modifications to the power train, suspension, and instrument cluster.

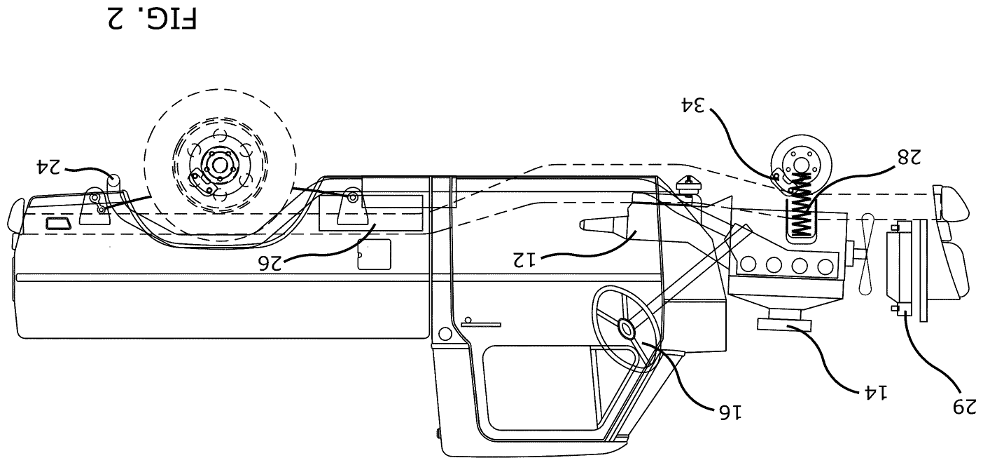

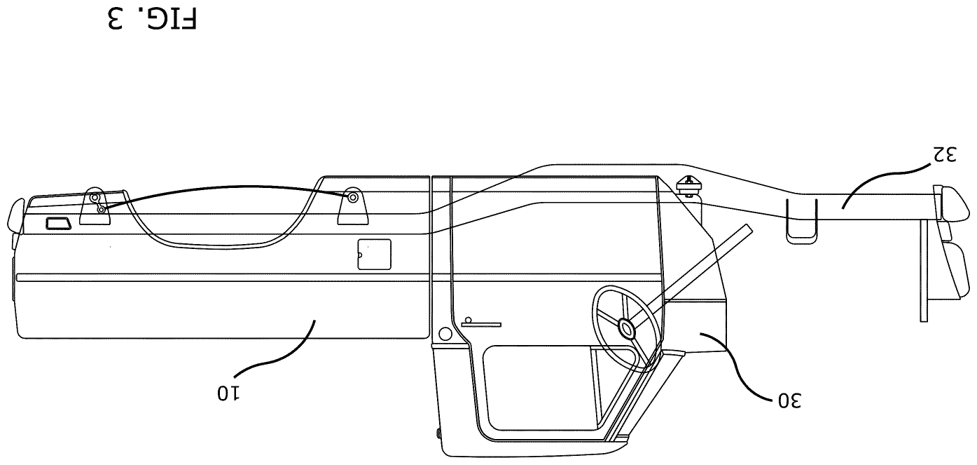

With reference to FIG. 2, various components and subsystems of the original vehicle are shown with portions of the chassis removed for clarity. The first step in the method of the present invention is to systematically remove the subsystems of the vehicle 10, beginning with the removal of the drivetrain. Removal of the drivetrain includes taking out the internal combustion engine (ICE) 14, transmission 12, drive shaft, differential and rear axle. Next the exhaust system 24 and fuel system 26 are removed, including the fuel tank. The radiator 29 and cooling system are then removed. Where the vehicle 10 is incapable of bearing the appropriate load distribution, the front suspension 28 (including coil springs, shock absorbers, cross members & brackets, steering and brake components) are removed, leaving the front part of the frame 30 bare, while exposing just both frame rails 32 as shown in FIG. 3.

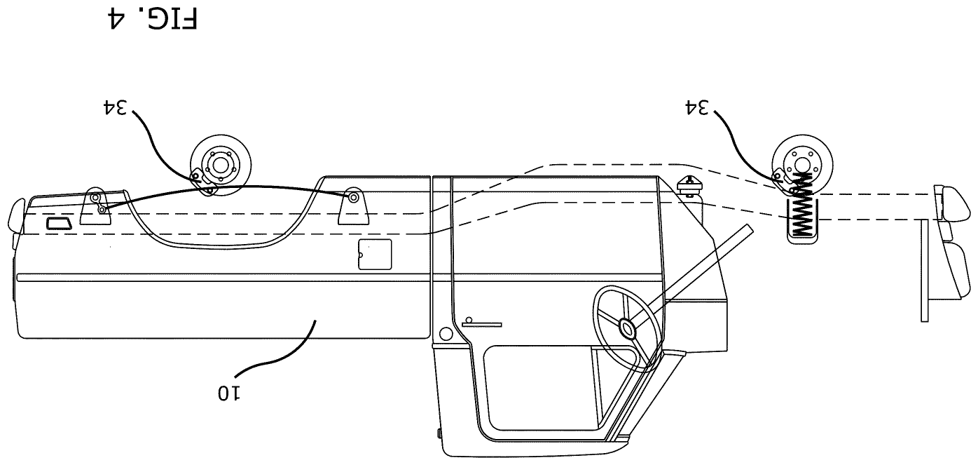

Certain pick-up trucks of this era were equipped with front and rear drum brakes. In the case of the Ford F-100, this was the case from 1967 through 1970 (however, 1971 and 1972 were upgraded with front disc brakes). Conversely, newer trucks have front and rear disc brakes with disk-caliper brake technology used in modern vehicles, giving a much better braking system, increasing its safety by reducing stopping distances and improving handling and stability. These disc brakes 34 are incorporated into the vehicle (see FIG. 4).

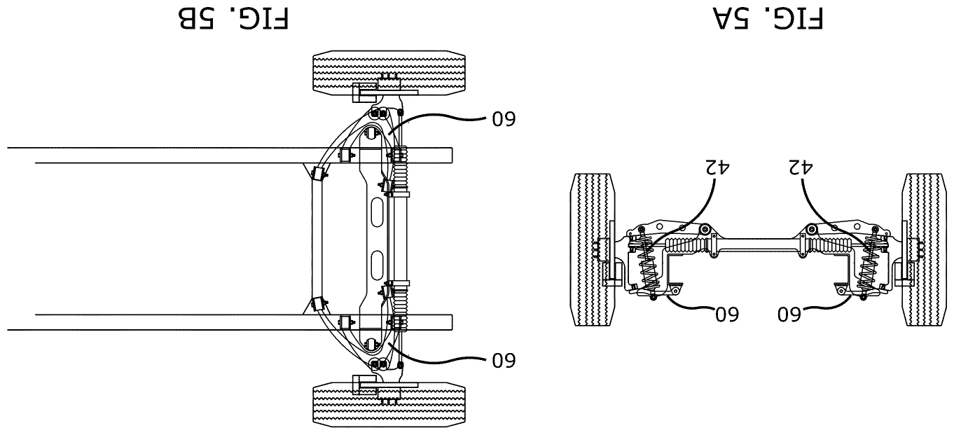

Ford trucks of the mid 1960s included a “Twin I Beam” suspension for the front on all “F” series pick-up as a response to the market of farmers and ranchers that needed to transport goods and/or pull trailers mainly on dirt or unpaved roads. As roadways were updated with asphalted or cemented surfaces, truck owners sought out vehicles that were better suited to travel at higher speeds with better handling and stability. Truck manufacturers replaced the “Twin I Beam” suspension with a double wishbone suspension that offered same payload capacity but improving handling and stability, and such trucks were capable of travel at higher speeds on today's modern roads. The reconstituted electric vehicle has the improved double wishbone (“SLA”) front suspension 40, resulting in a slightly lower ground clearance but greater handling and stability. Instead of a regular coil spring, the present invention is equipped with adjustable “Coil-Overs” 42 that are able to adjust dampening levels depending on driving style and/or roadway type (FIGS. 5A, 5B).

Historically, trucks of the late sixties and early seventies era were equipped with rear leaf springs. As technology advanced, leaf springs technology also advanced with a greater range of material selection, including better metal alloys and carbon fiber. These were used for production on some applications. Leaf springs have been improved with better elasticity properties while still maintaining their pay load capacity, offering a smoother ride. Leaf springs, however, have some drawbacks such as a propensity for “fishtailing” under certain load conditions, low cornering capacity, axle tramp on bumpy roads, etc. Accordingly, the present invention replaces the existing leaf springs with a “3-Link” ladder bar & coil spring suspension. Coil spring suspension is superior to a leaf spring in several ways. Coil springs can offer a true variable spring rate, are very easy to be upgraded and/or replaced by softer or harder coil springs, and the ride height can be adjusted. Overall, “3-Link” suspension on the rear improves the handling and stability without affecting payload capacity.

With the suspension in place, an electric trans-axle is installed added on an engineered and designed “C” support member. The “C” support member incorporates motor mounts, installation bracketry, a rear suspension, shock absorbers, and brakes on a single structure that is installed as a bolt-on to the clean and bare rear frame rails 32. A De Dion-style solid rear axle is constructed, with suitable space and bracketry to accommodate a direct drive electric motor 50. The motor 50 occupies the space where the differential and rear axle previously resided. This unitary design prevents axle wrap since the electric motor directs power at the rear wheels, thereby minimizing powertrain losses and maximizing efficiency.

The present invention involves the complete replacement of the entire drivetrain. Power to the rear wheels is directly conveyed into the wheel hubs, thereby reducing power loss experienced in the ICE design, to included piston to crankshaft, crankshaft to flywheel, flywheel to transmission, transmission to U-joint, U-joint to drive shaft, drive shaft to U-joint, U-joint to differential shaft, differential shaft to, differential gearing, gearing to output shafts/axle, then axle to wheel. Also, power for auxiliary equipment is provided through an additional dedicated auxiliary battery, similar to a standard vehicle battery, which supplies power to all “non-drive” related equipment, including instrument cluster, air-conditioning, lights, power windows, entertainment system, etc.

Automakers have been using steering gear boxes for long time since the introduction of the line production of automobiles at the beginning of the 1900's. Recently, pick-up vehicles were equipped with hydraulic or manual “Rack & Pinion” type of steering mechanism replacing the old steering gear box, improving handling and stability even on full size pick-up trucks. The steering gear box is replaced with an electrical gear box mounted on the steering column 16 and then connected to a “Rack & Pinion” steering system. This steering system does not depend on hydraulic pressure supplied by a power steering pump, and reduces components on the engine bay resulting in a low effort steering experience.

In the conversion to electrical power, the cooling system 54 requires a much smaller cooling capacity since heat generation is considerably reduced. However, the rear motor and trans-axle assembly produces some thermal energy that needs to be removed by means of passing coolant fluid circulating through a designated cooling system. The battery pack 56 is mounted in place where the internal combustion engine was previously located, and it requires some cooling that is achieved by positioning an electric fan to push fresh air over/through it. An improved aluminum radiator is installed replacing the copper factory radiator, and this aluminum radiator is also cooled by the electric fan.

The newly converted vehicle includes improved air conditioning resulting from multiple factors. First, the cab is not subjected to the prolific heat generation of an ICE on the engine bay that, consequently, passes heat to occupant's compartment. Second, an electric A/C compressor that works at a peak efficiency on the RPM keeps the driver's compartment cool at the desired and set levels providing a comfortable ambience inside the vehicle.

The entire exhaust system is removed without replacement since there is no exhaust produced by the electric motor or added heat to the bottom of the cab 62 and passenger compartment. The absence of the exhaust system translates to a quieter vehicle, both inside and outside, adding to the comfort of the ride.

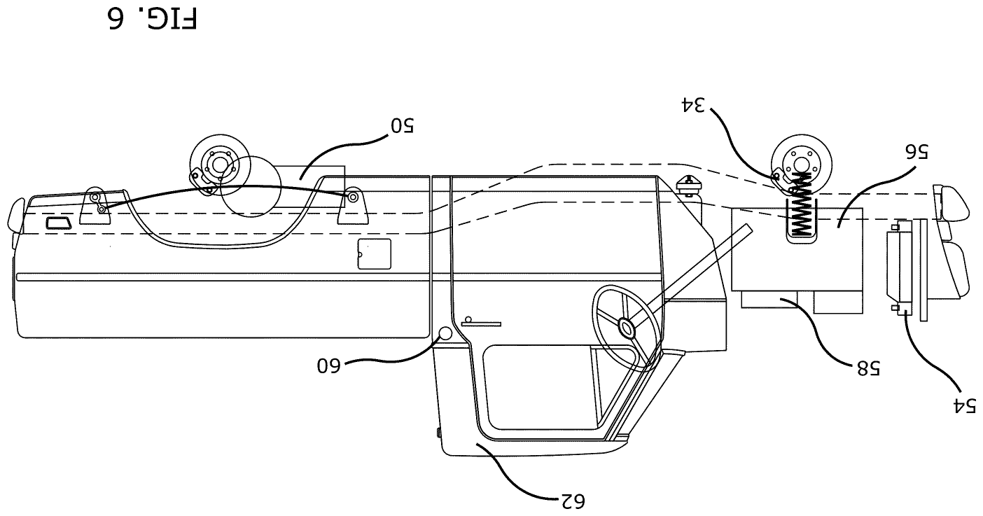

The reconstituted electric vehicle (FIG. 6) is equipped on the rear with the previously described “C” member referenced above. In one preferred embodiment, a 250+ mile range lithium base battery pack is mounted in the engine bay in place of the old ICE, including electronic controls 58 and required harness dedicated for the EV system as well as the un-altered factory functions such as lighting, A/C & heater, sound system, etc. A charging plug 60 is installed using the customized filler door behind the cab on the truck's bed on the driver's side. Inside the cab 62, the necessary controls and shifter are added to allow the driver to drive the electrified vehicle in a comfortable manner with even more amenities that the pre-modified truck. The interior is improved with three-point seatbelts, a re-designed bench seat, power windows, modern sound system, hands free phone connection, etc., but maintaining the vintage look without altering the factory vehicle's appearance on the exterior and cab interior. LED lighting may be added inside and outside the vehicle. Once assembled, acceleration is easily achieved with the electric 500 hp that replaces the relatively low horsepower ICE factory installed on the vehicle. The newly reconfigured vehicle gives its owner the feeling and the looks of a vintage vehicle with the greatly upgraded and redesigned suspension, steering and brake systems being able to offer a smooth ride, improved handling & stability, superior braking efficiency and control.

While the foregoing describes the inventors' preferred embodiments, the invention is not limited to the foregoing improvements. Various modifications and substitutions would be readily apparent to those of ordinary skill in the art, and the invention includes all such modifications and substitutions. Accordingly, unless otherwise expressly stated, the scope of the invention is properly determined by the appended claims using their customary and ordinary meanings and not limited to any specific depiction or description herein.

We claim:

1. A method for converting an internal combustion vehicle having a flatbed and a twin I beam suspension, comprising:
removing an internal combustion engine from the vehicle;
removing a transmission from the vehicle;
removing a drive shaft from the vehicle;
removing a differential from the vehicle;
removing a rear axle from the vehicle;
removing a front suspension from the vehicle;
removing a fuel system from the vehicle;
removing a radiator from the vehicle;
removing an exhaust system from the vehicle;
installing a C member and installing the rear axle to the C member;
installing disc brakes on each wheel of the vehicle;
installing a battery pack in a void where the internal combustion engine resided;
installing an electric fan to cool the battery pack;
installing an electric motor in a void where the differential resided and coupling said electric motor directly to wheels of the vehicle;
installing an auxiliary battery connected to non-propulsion functions;
installing a dedicated cooling system for cooling the electric motor, said dedicated cooling system including a circulating liquid coolant;
installing a charging plug;
installing an electric gear box on the steering column connected to a rack and pinion steering system; and
installing an air conditioning system that includes an electric air conditioning compressor.
